(19) United States
(12) Patent Application Publication
(10) Pub. No.: US 2005/0111064 A1
(43) Pub. Date: May 26, 2005

(54) Image reading device and image forming apparatus using the same

(76) Inventor: Takeshi Iwasaki, Saitama (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/967,226

(22) Filed: Oct. 19, 2004

(30) Foreign Application Priority Data
Oct. 20, 2003 (JP) 2003-359231 (JP)
Sep. 15, 2004 (JP) 2004-268278 (JP)

(51) Int. Cl. H04N 1/04

(52) U.S. Cl. 358/514; 358/474

(57) ABSTRACT

An image reading device of the present invention includes a plurality of image sensors divided in a direction of document conveyance and a first and a second roller pair respectively positioned upstream and downstream of the image sensors in the direction of document conveyance. A stepping motor causes the first and second roller pairs to rotate. A document sensor is positioned upstream of the second roller pair in the direction of document conveyance for sensing the document. The rotation speed of the stepping motor is reduced when a preselected period of time expires or when a preselected number of drive pulses are counted since the document sensor has sensed the leading edge of the document.

### BACKGROUND OF THE INVENTION

1. Field of the Invention

The present invention relates to a scanner or similar image reading device of the type including a plurality of reading means each covering particular part of a document in a direction of document conveyance, a first roller pair for conveying the document toward the reading means and a second roller pair for conveying it away from the reading means, and a copier, facsimile apparatus, printer, multifunction machine or similar image forming apparatus using the same.

2. Description of the Background Art

An image reading device of the type including a document table and a glass platen mounted on the document table is conventional. In this type of image reading device, a plurality of reading means each covering particular part of a document in a direction of document conveyance, a first roller pair for conveying the document toward the reading means and a second roller pair for conveying it away from the reading means are arranged below the glass platen. The second roller pair is larger in outside diameter than the first roller pair and rotatable in synchronism with the first roller pair. When a document is conveyed to a preselected position on the glass platen by the first roller pair, the reading means read the document via an SLA (Selfoc Lens Array). Subsequently, the document is conveyed away from the glass platen by the second roller pair. Analog image data output from the image reading means is digitized and then written to a memory for a moment.

While image sensors, constituting the reading means of the image reading device stated above, have been proposed in various forms in the past, they cannot implement sufficiently high image equality due to some problems that will be described specifically later.

### SUMMARY OF THE INVENTION

It is an object of the present invention to provide an image reading device capable of implementing high image quality and an image forming apparatus using the same.

An image reading device of the present invention includes a plurality of image sensors divided in a direction of document conveyance and a first and a second roller pair respectively positioned upstream and downstream of the image sensors in the direction of document conveyance. A stepping motor causes the first and second roller pairs to rotate. A document sensor is positioned upstream of the second roller pair in the direction of document conveyance for sensing the document. The rotation speed of the stepping motor is reduced when a preselected period of time expires or when a preselected number of drive pulses are counted since the document sensor has sensed the leading edge of the document.

An image forming apparatus including the above image reading device is also disclosed.

### BRIEF DESCRIPTION OF THE DRAWINGS

The above and other objects, features and advantages of the present invention will become more apparent from the following detailed description taken with the accompanying drawings in which:

FIGS. 1A, 1B and 1C are fragmentary perspective views each showing a particular configuration of a conventional image reading device;

FIG. 2A is a schematic block diagram showing circuitry included in the conventional image reading device of FIG. 1C;

FIG. 2B shows an image data shift caused by the circuitry shown in FIG. 1A;

FIG. 3A is a view demonstrating how image data is shifted when the leading edge of a document reaches a second roller pair included in the image reading device of FIGS. 2A and 2B more specifically;

FIG. 3B is a view similar to FIG. 3A, showing a image data shift to occur when the trailing edge of a document leaves a first roller pair also included in the image reading device of FIGS. 2A and 2B;

FIG. 4 is a section showing the general construction of an image forming apparatus to which an image reading device of the present invention is applied;

FIG. 5 shows an embodiment of the image reading device in accordance with the present invention;

FIG. 6 is a fragmentary enlarged section showing mechanical arrangements included in the illustrative embodiment;

FIG. 7 is a plan view also showing the mechanical arrangements of the illustrative embodiment;

FIG. 8 is a flowchart demonstrating a specific operation of the illustrative embodiment; and

FIG. 9 is a plan view showing an alternative embodiment of the present invention.

### DESCRIPTION OF THE PREFERRED EMBODIMENTS

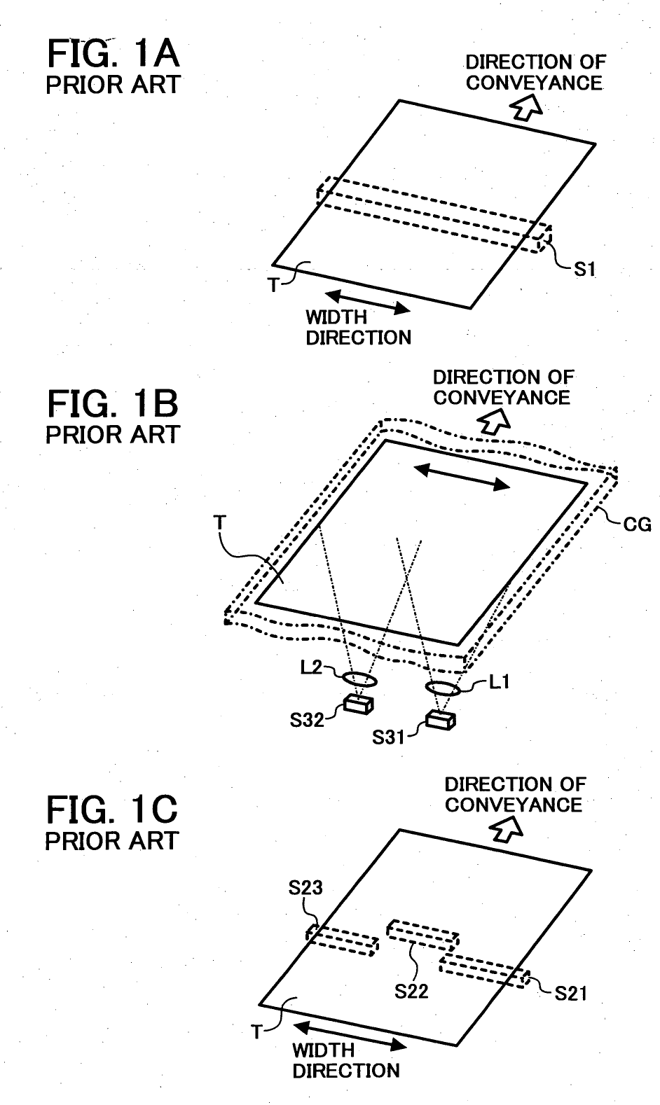

To better understand the present invention, brief reference will be made to some conventional image reading devices. FIG. 1A shows a conventional image reading device comprising a single image sensor S1 long enough to cover the maximum width of a document T and therefore capable of implementing high image quality with a simple configuration. However, if the maximum width to be read by the image sensor S1 is A0, then the image sensor S1 must be provided with length equal to A0. Such an image sensor is high cost and therefore increases the cost of the entire image reading device.

FIG. 1B shows another conventional image reading device implemented as a plurality of reduction type image sensors S31 and S32 each covering particular one of a plurality of zones divided in the widthwise direction of a document T. The image sensors S31 and S32 are located at the same position in a direction of conveyance in which the document T is conveyed. Reduction lenses L and L2 are associated with the image sensors S31 and S32, respectively. Labeled CG in FIG. 1B is a glass platen. Although the reduction type image sensors S31 and S32 are successful to reduce the production cost of the image reading device, a great optical length must be provided between each lens L1 or L2 and the image sensor S31 or S32 associated therewith, increasing the overall size of the image reading device.

FIG. 1C shows still another conventional image reading device made up of image sensors S21, S22 and S23 divided in the widthwise direction of a document T and each covering particular one of a plurality of zones divided in the direction perpendicular to the direction of conveyance. Image segments read by the image sensors S21 through S23 are combined by a controller not shown. This configuration is taught in Japanese Patent Laid-Open Publication No. 59-105762 by way of example. The image sensors S21 through S23 each are short and therefore low cost; the cost of the individual image sensor is proportional to length. However, the problem with this image reading device is that the image segments must be combined on the elapse of a preselected delay time, resulting in sophisticated data processing.

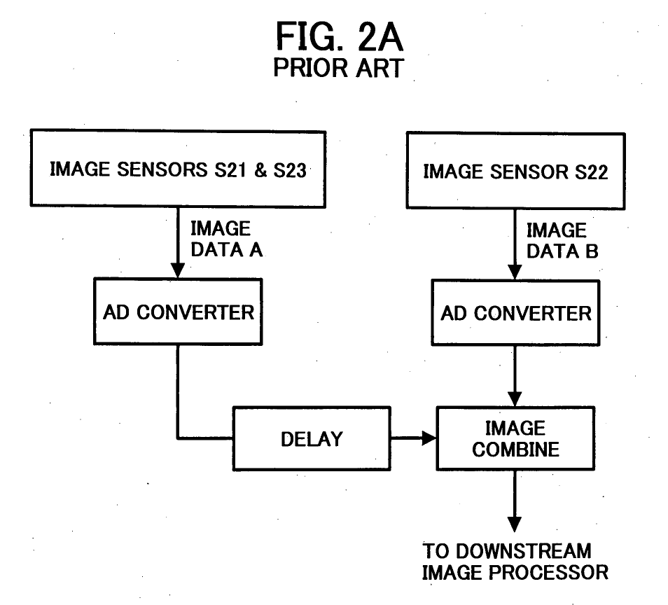

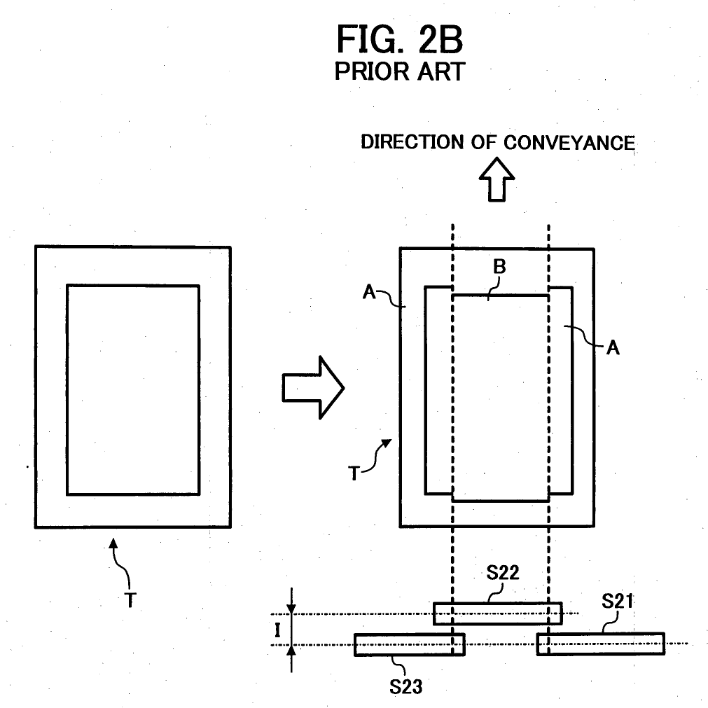

The image reading device shown in FIG. 1C will be described more specifically with reference to FIGS. 2A and 2B. As shown, the image sensors S21 and S23 positioned at the upstream side in the direction of document conveyance read part of the document in the widthwise direction. Subsequently, the image sensor S22 spaced from the image sensors S21 and S23 by a distance I at the downstream side reads the remaining part of the document T. Analog image data A output from the upstream image sensors S21 and S23 are digitized and then written to a preselected memory by a delay circuit. Subsequently, analog image data B output from the downstream image sensor S22 in a period of time corresponding to the distance I is digitized. The image data A and B are then combined by an image combining circuit.

The image sensors S21 through S23 are provided with positional accuracy in the direction of conveyance high enough for the image data A and B to be accurately combined in a faithful image. Further, the delay circuit, for example, is so adjusted as to make up for some short positional accuracy ascribable to members loaded with the image sensors S21 through S23. Such an image sensor configuration has the following problem left unsolved.

Generally, a second roller pair is positioned downstream of a first roller pair in the direction of conveyance, as stated previously. The second roller pair is driven at a higher linear velocity than the first roller pair, so that tension acts on the document T for thereby protecting it from creasing. It is therefore technically difficult to accurately combine the image data A and B output from the image sensors S21 through S23.

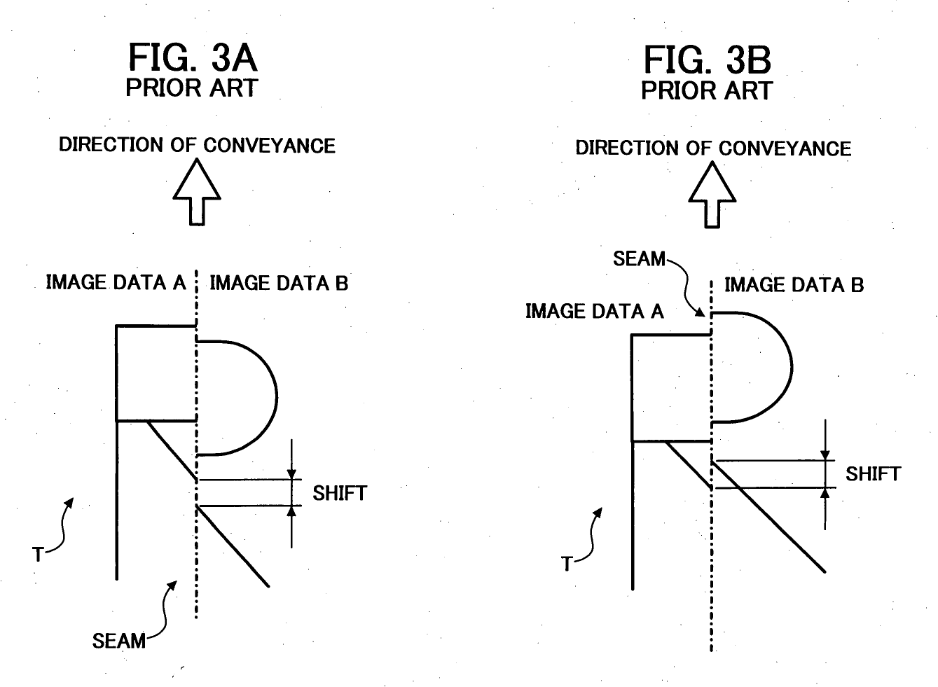

The speed of the document T being conveyed by the first or upstream roller pair changes when its leading edge is nipped by the second or downstream roller pair. More specifically, the document T is conveyed by the linear velocity of the first roller until it has been nipped by the second roller pair and is then conveyed by the linear velocity of the second roller pair. In this condition, assume that the image data A output from the image sensors S21 and S23 and image data B output from the image sensor S22 are combined in accordance with the linear velocity of the second roller pair. Then, as shown in FIG. 3A, when the leading edge of the document T is nipped by the second roller pair, the image data A output from the image sensor S21 or S23 is shifted forward from the image data B in the direction of conveyance at a seam between nearby zones. Let this image shift be referred to as a lead-edge shift hereinafter.

On the other hand, when the trailing edge of the document T leaves the first or upstream roller pair, the load of the first roller pair is canceled with the result that the speed of the document T being conveyed by the second roller pair increases for a moment. Consequently, as shown in FIG. 3B, the image data A output from the upstream image sensor S21 or S23 is shifted backward from the image data B at the seam between nearby zones in the direction of conveyance. This image shift will be referred to as a trail-edge shift hereinafter.

As for the amount of image shift stated above, assume that the outside diameters of the first and second roller pairs are 30.0 mm and 30.5 mm, respectively, and that the distance I between the upstream image sensors S21 and S23 and the downstream image sensor S22 in the direction of conveyance or subscanning direction is 30 mm. Then, because the outside diameter of the second roller pair is greater than the outside diameter of the first roller pair by 0.17%, a difference of about 50 μm occurs between the two roller pairs. Consequently, when the image sensors S21 through S23 read the document T with resolution of 600 dpi (dots per inch; 42.3 μm dot), more than one line of image shift occurs and degrades image quality.

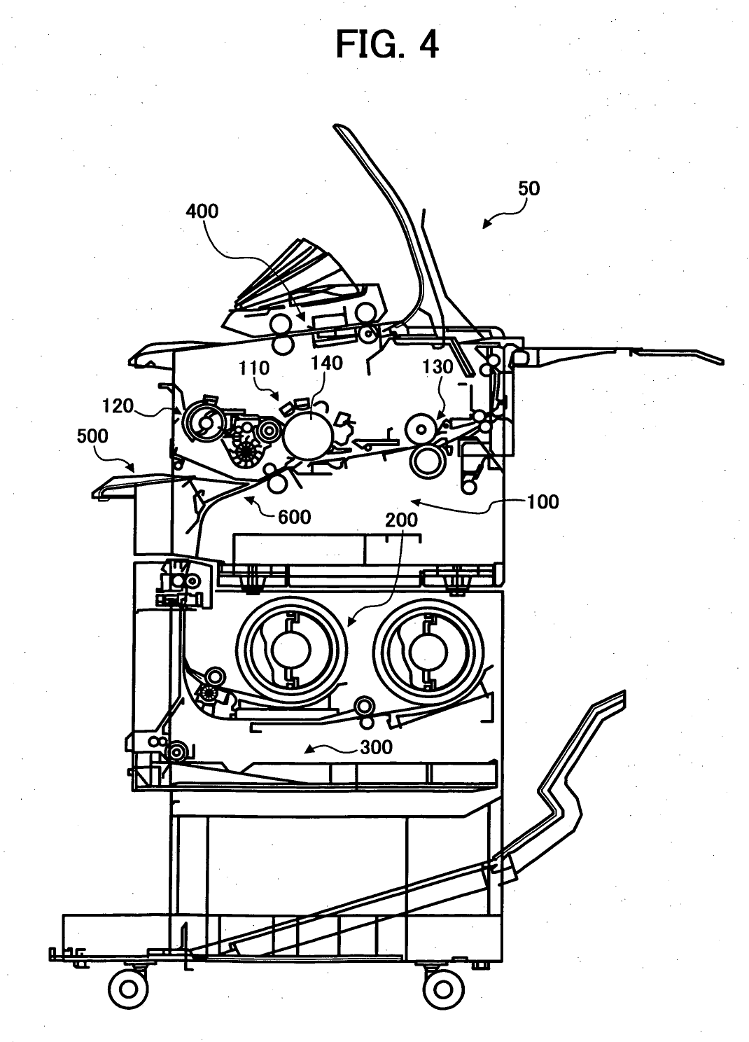

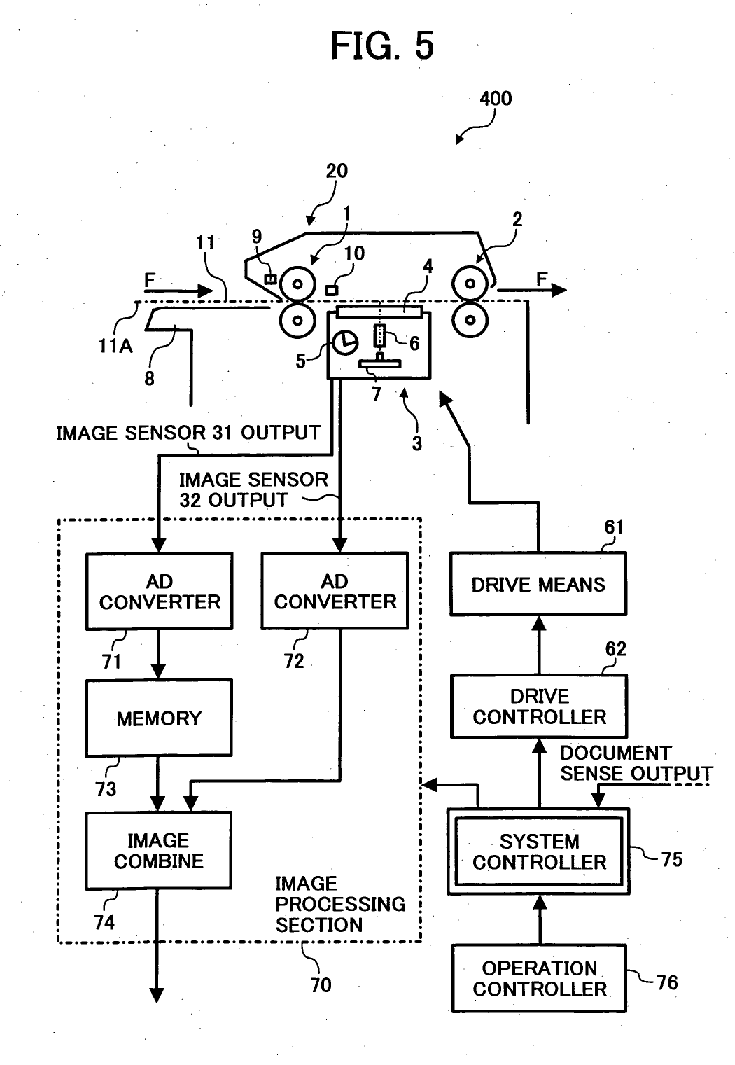

Referring to FIG. 4, an image forming apparatus including an image reading device embodying the present invention is shown and implemented as a copier by way of example. As shown, the copier, generally 50, includes an image forming section 100 positioned at substantially the center inside of the copier body. A roll type paper feeding section 200 and a cassette type paper feeding section 300 are arranged below the image forming section 100 while an image reading section or device 400 is positioned above the image forming section 100. The copier 500 additionally includes a manual sheet feeding section 500 and a sheet conveying section 600.

The image forming section 100 includes a writing unit 110, a rotatable photoconductive drum 140, developing unit 120 and a fixing unit 130, which are conventional. A charger, not shown, the writing unit 110, the developing unit 120, a cleaning unit, not shown, and so forth are arranged around the drum 140 in order to form an image on the drum 140.

In operation, the charger uniformly charges the surface of the drum 140 to preselected polarity. Subsequently, the writing unit 110 scans the surface of the drum 140 thus charged with a laser beam or similar optical signal derived from image data output from the image reading section 400, thereby forming an electrostatic latent image on the drum 140. The developing unit 120 develops the latent image with toner to thereby produce a corresponding toner image. Thereafter, the toner image is transferred from the drum 140 to a paper sheet fed from, e.g., the cassette type paper feeding section 300. The fixing unit 130 fixes the toner image on the paper sheet with heat and pressure as conventional.

Reference will be made to FIGS. 5 through 7 for describing the image reading device of the illustrative embodiment more specifically. As shown, the image reading device, generally 400, includes image reading means or image sensor 3 configured to read a document 11 by dividing it in a direction of conveyance F on a document table 8. A pair of first rollers 1 are rotatable about respective shafts 1a for conveying the document 11 toward the reading means 3. A pair of second rollers 2 are rotatable about respective shafts 2a for conveying the document 11 away from the reading means 3. The reference numeral 20 designates a top cover.

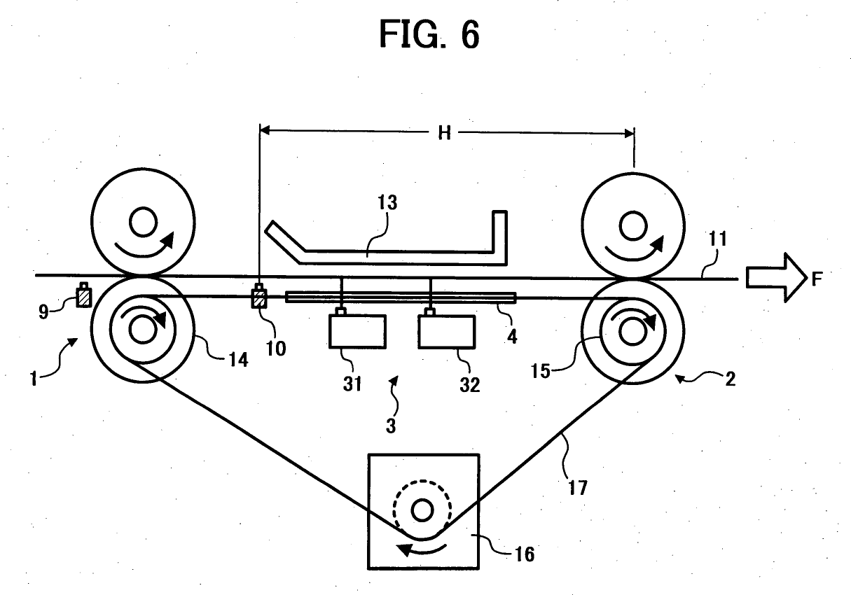

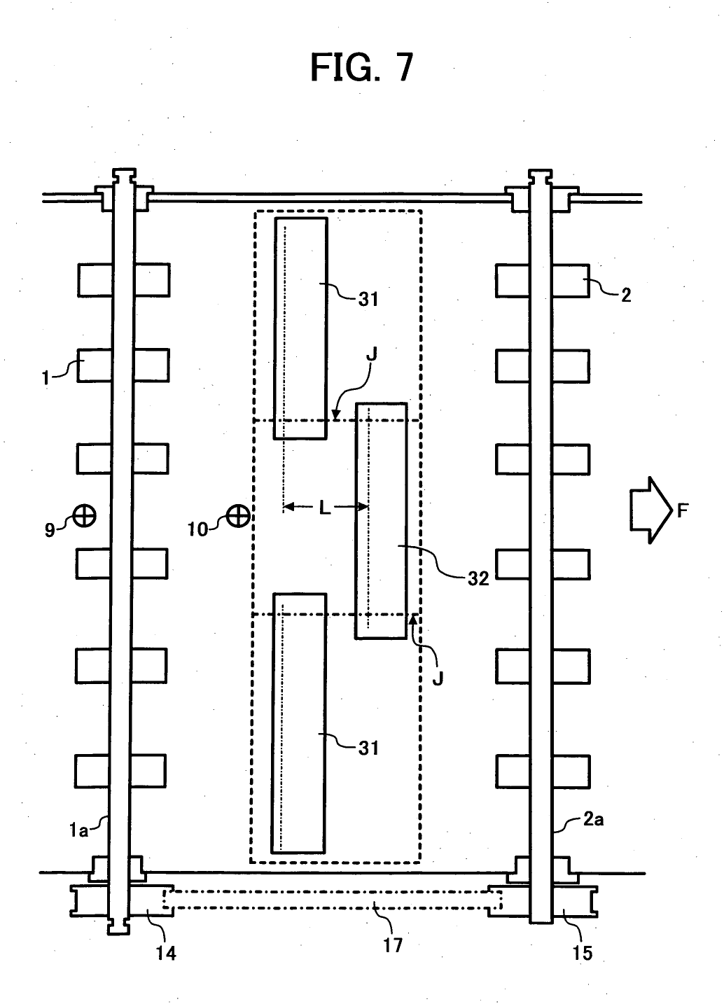

The reading means 3 includes a glass platen 4 mounted on the top of the document table 8, illuminating means 5, an SLA 6, and a plurality of light-sensitive devices 7, i.e., a pair of first image sensors 31 and a second image sensor 32, see FIG. 7. As shown in FIG. 7, the second image sensor 32 is spaced from the first image sensors 31 by a distance L at the downstream side in a direction of conveyance F in which a document 11, see FIG. 6, is conveyed. A reading zone assigned to each of the image sensors 31 and a reading zone assigned to the image sensor 32 overlap each other by a preselected amount in the widthwise direction of the document 11. Labeled J in FIG. 7 is a seam between nearby reading zones. As shown in FIG. 5, the upper first roller 1 and upper second roller 2 are mounted on the top cover 20. Image data signals output from the light-sensitive devices 7 each are converted to digital data by a particular AD (Analog-to-Digital) converter and then written to a memory, as will be described more specifically later.

As shown in FIGS. 6 and 7, document sensing means 9 is positioned upstream of the first rollers 1 in the direction of conveyance F. Second document sensing means 10 is positioned downstream of the first rollers 1 in the above direction F in order to implement, e.g., a read start timing. Drive means 61 causes the first and second rollers 1 and 2 to rotate under the control of a drive controller or drive control means 62. More specifically, in the illustrative embodiment, a timing belt 17 is passed over a first pulley 14 and a second pulley 15 coaxial with the lower first roller 1 and lower second roller 2, respectively, and caused to turn by a stepping motor 16.

An image processing section 70 includes AD converters 71 and 72, a memory 73 connected to the AD converter 71, and an image combiner 62 configured to combine image data output from the memory 73 and AD converter 72. The drive controller 62 and image processing section 70 both are controlled by a system controller 75. The operator of the copier 50 is expected to input various commands and information on an operation controller 76 also connected to the system controller 75. It is to be noted that arrows shown in FIG. 5 are representative of the main flows of data signals and control signals.

As shown in FIG. 6, in the illustrative embodiment, when the document 11 is conveyed by the first rollers 1 to a preselected position between the glass platen 4 and a pressing plate 13, the first and second image sensors 31 and 32, divided in the direction of conveyance F and spaced from each other, read the document 11. The document 11 is then driven away from the glass platen 4 by the second rollers 2. Resulting image data output from the first image sensors 31 and image data output from the second image sensor 32 are input to the AD converters 71 and 72, respectively, and converted to digital image data each having 256 consecutive tones thereby. Subsequently, the image data output from the AD converter 71 is written to the memory 73 and delayed by a preselected period of time thereby. The image data thus delayed by the memory 73 and the image data output from the AD converter 72 are combined by the image combiner 74 and then output as one line of image data.

The configuration of the image processing section described above is only illustrative. If desired, digital signals output from all image sensors may be input to a single AD converter and converted to digital data thereby while being switched with each other. Further, digital signals output from all image sensors may be written to a memory and then substantially combined when they are read out of the memory.

The first and second rollers 1 and 2 are configured to protect the document 11 brought to the reading means 3 from creasing that would bring about defective reading. More specifically, the second rollers 2 are provided with a slightly larger outside diameter than the first rollers 1 and driven at a linear velocity LV2 higher than the linear velocity LV1 of the first rollers. In this condition, the second rollers 2 convey the document 11 while pulling it, i.e., exerting tension thereon. In the illustrative embodiment, each first roller 1 has a diameter 30 mm while each second roller 2 has a diameter of 30.5 mm, which is larger than the former by about 0.17%, although such diameters are not limitative.

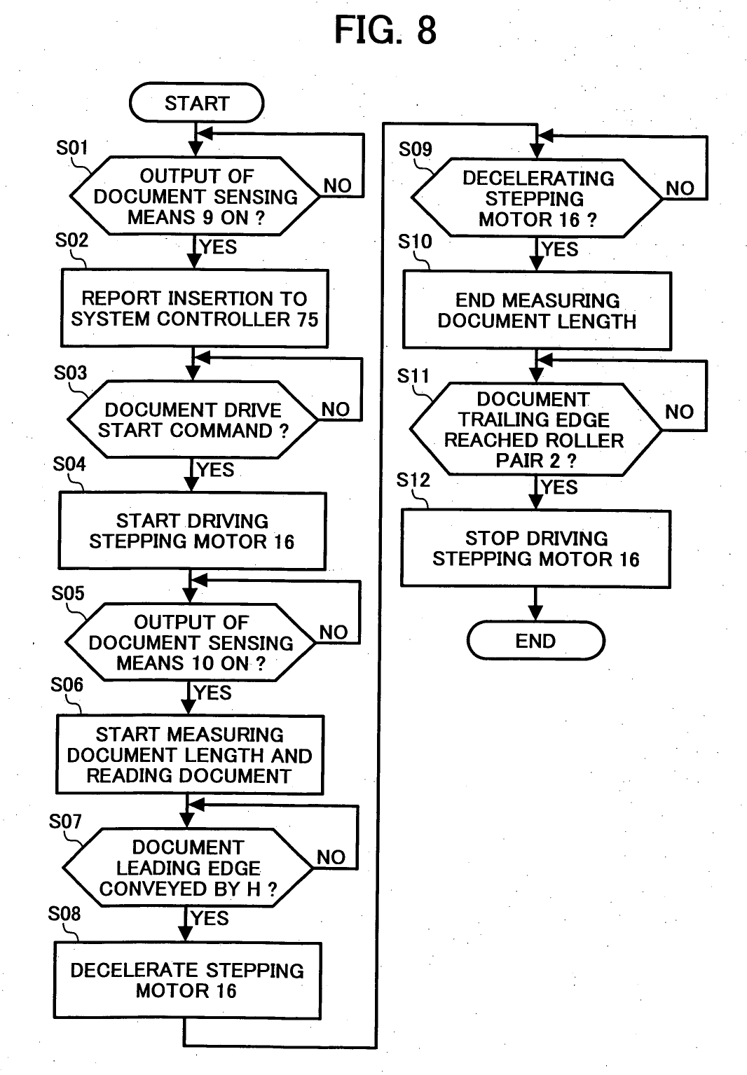

A specific procedure in which the illustrative embodiment outputs image data by reading the document 11 will be described with reference to FIG. 8. As shown, when the first document sensing means 9 senses the document 11 laid on the document table 8 (YES, step S01), the image reading device determines that the document 11 has been inserted and then informs the system controller 75 of the insertion (step S02). Subsequently, on receiving a document drive start command input on the operation controller 76 (YES, step S03), the system controller 75 causes the drive controller 62 to start driving the stepping motor 16 (step S04). As a result, the drive means 61 causes the first and second rollers 1 and 2 to rotate in synchronism with each other, the first rollers 1 conveying the document 11 at a preselected first speed.

When the second document sensing means 10 senses the leading edge of the document 11 (YES, step S05), the system controller 75 starts measuring the amount of movement, i.e., the length of the document 11 and starts reading the document 11 (step S06). More specifically, the reading means 3 continuously reads the document 11 being conveyed by the first rollers 11. The resulting signals output from the reading means 3 are sequentially processed.

The image reading procedure will be described more specifically hereinafter. The illuminating means 5 included in the reading means 3 illuminates the image surface 11A of the document 11 with a preselected quantity of light. The resulting reflection from the image surface 11A and representative of an image pattern is focused on the light-sensitive devices 7 via the SLA 6 at the same magnification. In response, the light-sensitive devices 7, i.e., the first and second image sensors 31 and 32 each output a particular analog image signal corresponding to a quantity of light incident thereto. The AD converters 71 and 72 respectively convert the analog output levels of the image sensors 31 and 32 to corresponding digital image data. The digital data output from the AD converter 71 is written to the memory 73.

Subsequently, when the image data read by the second image sensor 32 is output, i.e., on the elapse of a period of time T since the document 11 has passed the first image sensors 31, the image segments are combined in a single line and then fed to an image adjusting circuit, not shown, that follows the image processing section 70. In this manner, image data are sequentially output in consecutive lines (main scanning direction) in the direction of document conveyance (subscanning direction).

Until the leading edge of the document 11 being continuously read by the above procedure has been nipped by the second rollers 2, i.e., when the first rollers 1 are conveying the document 11 alone, the stepping motor or drive means 16 is driven at a constant speed that maintains the linear velocity LV1 of the first rollers 1 constant at c. As soon as the leading edge of the document 11 is nipped by the second rollers 2, the stepping motor 16 is decelerated to lower the linear velocity LV2 of the second rollers 2 to c in consideration of a load particular to the first rollers 1. To decelerate the stepping motor 16, the period of drive pulses input to the stepping motor 16 may be reduced by way of example.

More specifically, when the second rollers 2 nip the document 11, a preselected value set in the drive controller 62 beforehand is so varied as to cause the linear velocity VL2 of the second rollers 2 to coincide with the linear velocity LV1 at which the first rollers 1 have rotated before the above nip. At this instant, the deceleration ratio of the stepping motor 16, i.e., the ratio of the rotation speed before deceleration to the rotation speed after deceleration is substantially equal to the ratio of the outside diameter of the second rollers 2 to that of the first rollers 1 and is therefore 0.17%. In this manner, the drive controller or drive control means 62 controls the stepping motor or drive means 16 such that the linear velocity LV2 of the second rollers during actual conveyance coincides with the linear velocity LV1 of the first rollers 1 during actual conveyance.

In the illustrative embodiment, to maintain the document conveying speed substantially constant, the system controller 75 supervises a section H, see FIG. 6, between the time when the second document sensing means 10 senses the leading edge of the document 11 and the time when the second rollers 2 nip the document 11. The above section H is represented by a period of time produced by dividing the distance between the second document sensing means 10 and the second rollers 2 by the linear velocity LV1, before deceleration, of the first rollers 1.

By counting the period of time mentioned above with a timer, not shown, the system controller 75 determines that the leading edge of the document 11 has reached the second rollers 2. Alternatively, the system controller 75 may count a preselected number of drive pulses corresponding to the above preselected period of time, i.e., produced by dividing the preselected period of time by the period of drive pulses. In the case of a drive mechanism of the type allowing the number of pulses input to a stepping motor to precisely match with a distance which the circumference of, e.g., each first roller 1 moves, the number of pulses may be directly produced from the distance of the section H.

More specifically, in the specific procedure shown in FIG. 8, when the second document sensing means 10 senses the leading edge of the document 11 being conveyed (YES, step S05), the system controller 75 starts measuring the length of the document 11 (step S06), i.e., starts counting the preselected interval between the time when the second document sensing means 10 senses the leading edge of the document 11 and the time when the second rollers 2 nip it. On the elapse of the above period of time, the system controller 75 determines that the leading edge of the document 11 has reached the second rollers 2 (YES, step S07). The system controller 75 then varies the value set in the drive controller 62 so as to decelerate the stepping motor 16, as stated earlier. Consequently, the linear velocity VL2 of the second rollers 2 is reduced to c. (step S08).

By the procedure described above, the document 11 is conveyed at the same speed before and after its leading edge has been nipped by the second rollers 2. This successfully obviates image shifts otherwise occurring in the subscanning direction at the seams between the first and second image sensors 31 and 32, thereby insuring high image quality.

In the illustrative embodiment, by supervising the section H, FIG. 6, between the time when the second document sensing means 10 senses the trailing edge of the document 11 and the time when the document 11 leaves the second rollers 2, the system controller 75 causes the stepping motor 16 to stop rotating. A period of time necessary for the trailing edge of the document 11 to travel the section H is also produced by dividing the distance between the second document sensing means 10 and the second rollers 2 by the linear velocity of the first rollers 1 before deceleration, i.e., equal to the preselected period of time stated previously. On the elapse of the above period of time, the system controller 75 determines that the trailing edge of the document 11 has moved away from the second rollers 2. Again, to make such a decision, the system controller 75 may count a preselected number of drive pulses corresponding to the preselected period of time, if desired.

More specifically, in FIG. 8, when the second document sensing means 10 senses the trailing edge of the document 11 being conveyed (YES, step S09), the system controller 75 ends measuring the length of the document 11 (step S10).

The preselected interval between the time when the leading edge of the document 11 is sensed by the second document sensing means 10 and the time when it is nipped by the second rollers 2 is equal to the interval between the time when the trailing edge of the document 11 is sensed by the second document sensing means 10 and the time when it leaves the second rollers 2, as stated above. Therefore, by counting time since the output of the second document sensing means 10 has gone off (YES, step S09), the system controller 75 determines, on the elapse of the preselected period of time, that the trailing edge of the document 11 has left the second rollers 2 (YES, step S11) and then causes the drive means 61 to stop rotating the stepping motor 16.

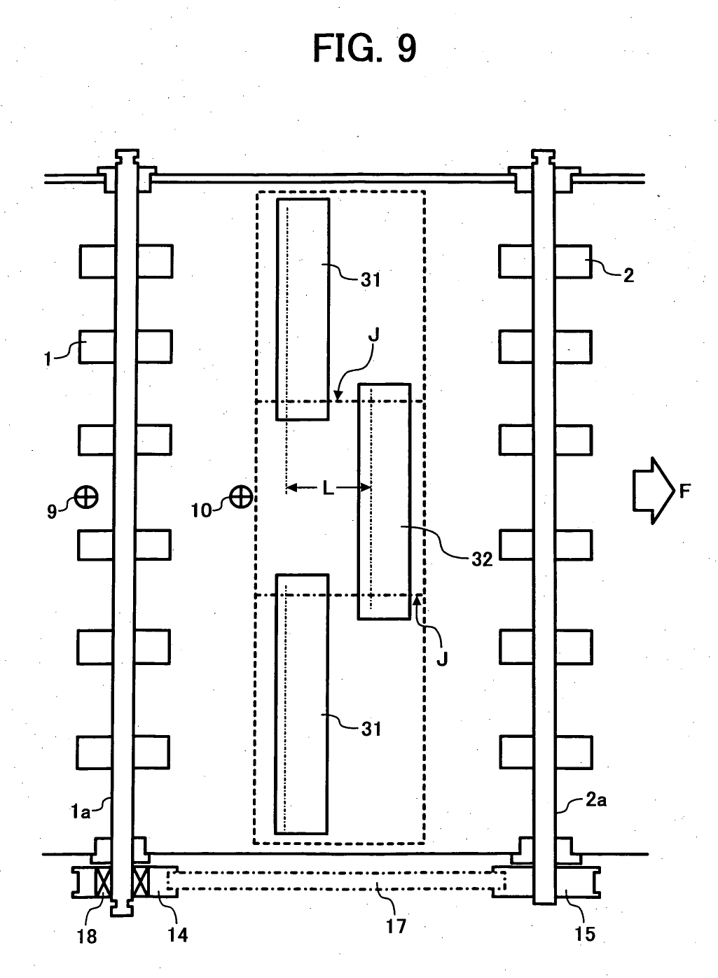

Hereinafter will be described an alternative embodiment of the present invention configured to obviate the trail-edge shift of an image stated earlier. FIG. 9 is a view similar to FIG. 7, showing essential part of mechanical arrangements included in the illustrative embodiments. As shown, the illustrative embodiment differs from the previous embodiment in that a one-way clutch or speed control means 18 is mounted on one end of the shaft 1a of each first roller 1, and that the first pulley 14 is mounted via the one-way clutch 18. In FIG. 9, structural elements identical with those shown in FIG. 7 are designated by identical reference numerals and will not be described specifically in order to avoid redundancy.

When the leading edge of the document 11 being conveyed by the first rollers 1 is nipped by the second rollers 2, the linear velocity LV2 of the second rollers 2 is made equal to the linear velocity LV1 of the first rollers 1 by the same control as executed in the previous embodiment. At the same time, because the linear velocity LV1 is always lower than the linear velocity LV2, the rotation of the shaft 1a, which supports the first roller 1, and the rotation of the first pulley 14 are rendered free by the one-way clutch 18, so that the rollers 1 are rotated by the rollers 2 via the document 11. Consequently, only the inertial resistance of the rollers 1 acts on the document 11 as tension with the result that the conveying speed varies little despite the tension of the document 11 when the trailing edge of the document 11 leaves the rollers 1. This insures high-quality image reading free from image shifts even at the trailing edge of the document 11.

As stated above, to make the linear velocities LV1 and LV2 of the first and second rollers 1 and 2, respectively, equal when the reading means is reading the document 11, the illustrative embodiment uses speed control means implemented by the stepping motor or drive means 16, control means for controlling the stepping motor 16, and one-way clutch or clutch means 18 mounted on the shaft 1a of the first roller 1. The illustrative embodiment therefore obviates both of lead-edge shift and trail-edge shift described with reference to FIGS. 3A and 3B, respectively.

While the embodiment shown in FIG. 9 uses relatively low cost, one-way clutches as a clutch mechanism, one-way clutches may be replaced with, e.g., solenoid-operated clutches that can be adequately, selectively coupled or uncoupled in accordance with the position of the leading edge of the document 11, i.e., the amount of movement of the document 11.

In summary, it will be seen that the present invention provides a document reading device capable of protecting an image from shifts despite that a plurality of reading means each read particular one of a plurality of portions of a document divided in the direction of document conveyance, thereby insuring high image quality. Such an image reading device is applicable to an image forming apparatus to provide it with high image quality.

Various modifications will become possible for those skilled in the art after receiving the teachings of the present disclosure without departing from the scope thereof.

1. An image reading device comprising:
a plurality of reading means divided in a direction of conveyance in which a document is conveyed;
a first roller pair positioned upstream of said plurality of reading means in the direction of conveyance;
a second roller pair positioned downstream of said plurality of reading means in the direction of conveyance;
drive means for causing said first roller pair and said second roller pair to rotate; and
document sensing means positioned upstream of said second roller pair in the direction of conveyance for sensing the document;
wherein a rotation speed of said drive means is reduced when a preselected period of time expires or when a preselected number of drive pulses are counted since said document sensing means has sensed a leading edge of the document.

2. The device as claimed in claim 1, wherein a deceleration ratio of said drive means, which is a ratio of a rotation speed of said drive means before speed reduction to a rotation speed of said drive means after speed reduction, is substantially equal to a ratio of an outside diameter of said second roller pair to an outside diameter of said first roller pair.

3. The device as claimed in claim 1, wherein the preselected period of time or the preselected number of drive pulses is respectively a period of time produced by dividing a distance between said document sensing means and said second roller pair by a linear velocity of said first roller pair before speed reduction or a value corresponding to said period of time.

4. The device as claimed in claim 1, further comprising control means for controlling said drive means.

5. The device as claimed in claim 4, wherein said control means comprises adjusting means for adjusting an amount of speed reduction.

6. The device as claimed in claim 4, wherein said control means comprises a timer configured to count the preselected period of time.

7. The device as claimed in claim 1, further comprising clutch means associated with said first roller pair for allowing said first roller pair to follow rotation of said second roller pair.

8. In an image forming apparatus including an image reading device, said image reading device comprising:
a plurality of reading means divided in a direction of conveyance in which a document is conveyed;
a first roller pair positioned upstream of said plurality of reading means in the direction of conveyance;
a second roller pair positioned downstream of said plurality of reading means in the direction of conveyance;
drive means for causing said first roller pair and said second roller pair to rotate; and
document sensing means positioned upstream of said second roller pair in the direction of conveyance for sensing the document;
wherein a rotation speed of said drive means is reduced when a preselected period of time expires or when a preselected number of drive pulses are counted since said document sensing means has sensed a leading edge of the document.

9. The apparatus as claimed in claim 8, further comprising control means for controlling said drive means.

10. The apparatus as claimed in claim 9, wherein control means comprises a timer configured to count the preselected period of time.

11. The apparatus as claimed in claim 9, wherein said control means comprises adjusting means for adjusting an amount of speed reduction.
